(19) United States
(12) Patent Application Publication
(10) Pub. No.: US 2014/0304139 A1
(43) Pub. Date: Oct. 9, 2014

(54) SYSTEM AND METHOD FOR TRADING DIVIDEND YIELDING SECURITIES

(71) Applicant: Kevin Shacknofsky, New Rochelle, NY (US)

(72) Inventor: Kevin Shacknofsky, New Rochelle, NY (US)

(21) Appl. No.: 14/247,642

(22) Filed: Apr. 8, 2014

Related U.S. Application Data
(60) Provisional application No. 61/809,683, filed on Apr. 8, 2013.
(60) Provisional application No. 61/944,721, filed on Feb. 26, 2014.

(51) Int. Cl. G06Q 40/04

(52) U.S. Cl. CPC G06Q 40/04
USPC 705/37

(57) ABSTRACT

In one or more implementations, an exchange traded fund is used to receive a dividend that exceeds an underlying market index on which the exchange traded fund is based, and earning a total return that is correlated to the at least one underlying index. Security information is referenced that represents respective securities, security price(s), ex-dividend date(s), and dividend yield(s). One or more processors receive investment information that represents a first portion of a portfolio that includes one or more investments in one or more securities in relation to the at least one underlying index. The investment information and at least some of the security information is processed to determine a second portion of the portfolio that includes at least two of the respective securities to be purchased prior to the respective ex-dividend date. The processor(s) initiate an investment in each of the at least two securities.

### CROSS-REFERENCE TO RELATED APPLICATION

The present application claims the benefit of U.S. patent application Ser. No. 61/809,683, filed Apr. 8, 2013, and U.S. patent application Ser. No. 61/944,721, filed Feb. 26, 2014, the contents of each of which are hereby incorporated by reference in their respective entireties.

### FIELD OF INVENTION

The present application relates, generally, to automating investment strategy and, more particularly, to trading dividend yielding securities to earn a dividend that exceeds an underlying market index on which an exchange traded fund is based.

### BACKGROUND

An exchange traded fund (“ETF”) includes a security that is managed to replicate as close as possible the performance of an underlying index of stocks that the EFT is designed to emulate. ETFs are useful by allowing investors to benefit from economies of scale, by spreading administration and transaction costs over a large number of investments.

Unfortunately, this management of the ETF results in the ETF having a dividend that is similar to the dividend of its correlated index. Due to the likelihood of a conservative return, an investor would prefer that an ETF provide a higher dividend that that of its underlying index.

One known way to increase the dividend of an ETF is to use leverage to boost the ETF's return and dividend. However leveraged exchange traded funds are far more volatile and thus are more risky investments than non-leveraged ETFs. In one example, a leveraged ETF mirrors an index fund, but uses borrowed capital in addition to investor equity to provide a higher level of investment exposure. The expectation of the investors is that the investments will appreciate with the borrowed capital, and that appreciation will exceed the cost of the capital itself. Such expectation may not be met, however, given the relative volatility of the investment.

Notwithstanding the relatively low return and dividend associated with an ETF, ETFs have advantages over other investments, including mutual funds. For example unlike mutual funds, an investor can invest in ETFs during the day at a transparent market price, as opposed to a mutual fund, which someone can only invest in once a day, when the market is closed. Moreover, generally ETFs are more tax efficient than mutual funds, and ETFs generally have lower investment minimums than mutual funds.

In one known system, Bloomberg or similar system is used to produce a global universe of dividend paying stocks with a minimum yield. Using traditional investment analysis techniques, a portfolio of 30-120 stocks is produced. Thereafter, the holdings are weighted based on risk return judgment. Bloomberg or similar system is used to provide a daily report that shows all dividends that have been declared globally and using judgment. Thereafter, dividends are chosen to trade by buying them before the ex-date, which may be the date on or after which a security is traded without a previously declared dividend or distribution. As used herein, after the ex-date, a stock is traded ex-dividend. Based on new information e.g. earnings reports and economic data, stocks are removed and added to the portfolio. If there are no attractive new investments, then cash can be held for up to 10% of the portfolio. New cash invested in the fund is invested in existing or new holdings based on judgment.

### SUMMARY OF THE INVENTION

In one or more implementations, a system and method are provided that use an exchange traded fund to receive a dividend that exceeds at least one underlying market index on which the exchange traded fund is based, and earning a total return that is correlated to the at least one underlying index. At least one processor accesses database(s) that include security information. The security information can represent respective securities, security price(s), ex-dividend date(s), and dividend yield(s). The ex-dividend date represents a date when a dividend is announced or paid.

Continuing with the one or more implementations, the processor receives investment information that represents a first portion of a portfolio that includes one or more investments in one or more securities in relation to the at least one underlying index. The processor(s) process the investment information and at least some of the security information in the database(s) to determine a second portion of the portfolio that represents less than half of the first portion of the portfolio and that includes at least two of the respective securities to be purchased prior to the respective ex-dividend date for each of the at least two securities. Based on that processing, the processor(s) initiate an investment in each of the at least two securities, and output a confirmation of the investment of the second portion of the portfolio.

In yet another aspect of the present application, the processor(s) can initiate a sale of any portion of the portfolio that has paid a dividend, and identify at least one other of the securities to be purchased prior to the respective ex-dividend date. The processor(s) can initiate an investment in each of the at least one other of the securities and output a confirmation of the investment of the at least one other of the securities.

In yet another aspect of the present application, the processor(s) can identify historical returns of at least some of the respective securities in the at least one database, as well as an optimal holding period for at least some of the respective securities. The processor(s) can further determine a Beta value that represents a correlated volatility for one or more of the securities having an ex-dividend date within a respective range in relation to a volatility of a benchmark the one or more securities are compared to.

In yet another aspect of the present application, a system and method are provided that include initiating, with respect to a first portion of a portfolio, one or more first transactions. The one or more first transactions include one or more investments in one or more securities in relation to one or more market indices. Further, one or more securities are identified with respect to which (a) a dividend has been declared and (b) that are correlated to the one or more market indices. For each of the identified one or more securities: historical data associated with the security are processed, in which the historical data includes (a) one or more returns occurring before an ex-dividend date of the security and (b) one or more returns occurring after an ex-dividend date of the security, in order to determine an optimal holding period for the security. A correlated volatility value of the security with respect to the one or more securities is determined and processed for each of the identified one or more securities in order to determine one or more of the identified one or more securities having an aggregate comparable volatility to the one or more market indices. For each of the determined one or more of the identified one or more securities: the system and method include initiating, prior to an ex-dividend date of the security and with respect to a second portion of the portfolio, an investment in the security; and based on a determination that an ex-dividend date of the security has arrived, initiating one or more second transactions with respect to the determined one or more of the identified one or more securities.

Other features and advantages of the present application are shown with reference to the accompanying drawing figures, by way of example only, and described below.

### BRIEF DESCRIPTION OF THE DRAWINGS

FIG. 1 shows an example hardware arrangement for viewing, reviewing and outputting content in accordance with an implementation;

FIG. 2 is a block diagram that illustrates functional elements of a computing device in accordance with an embodiment; and

FIGS. 3 and 4 are flowcharts showing example steps associated with processes in accordance with at least one implementation of the present application.

### DETAILED DESCRIPTION OF EMBODIMENTS

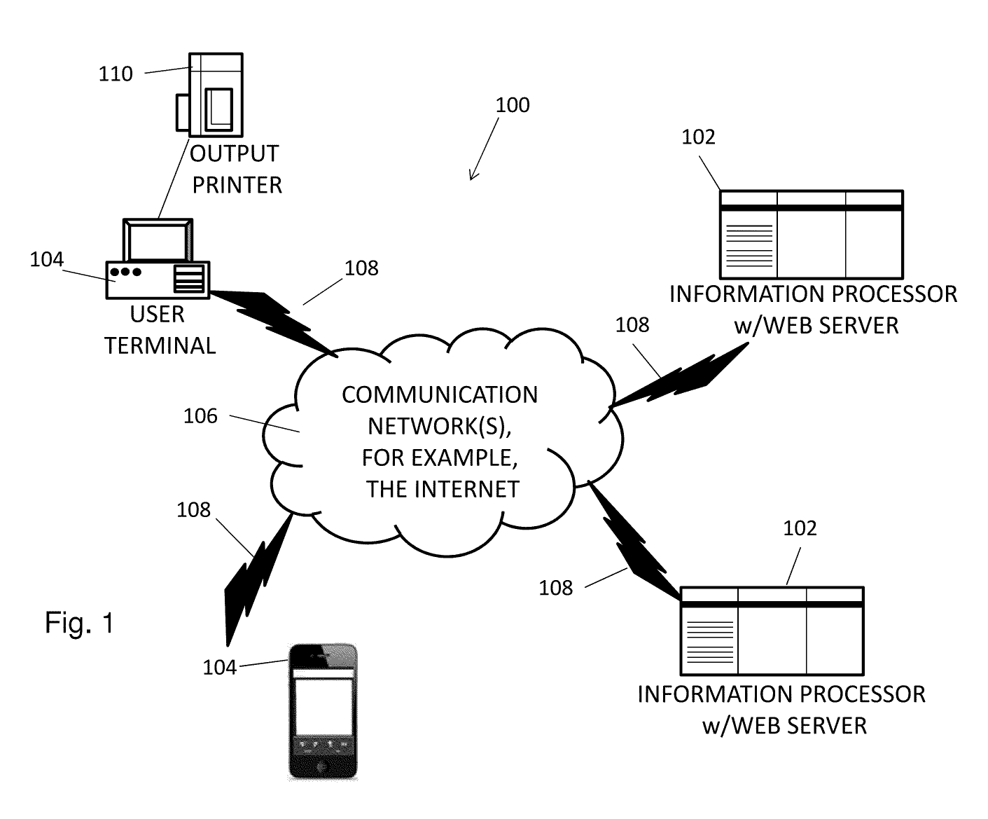

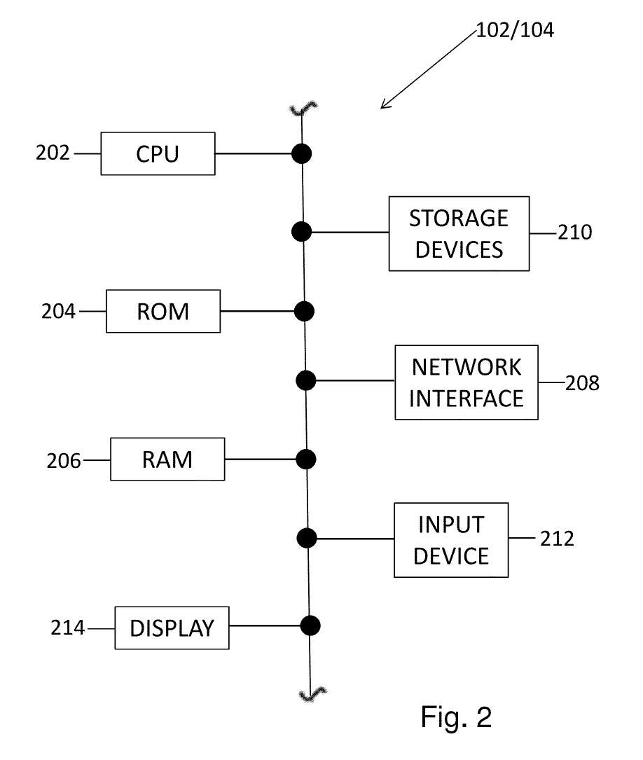

Referring to FIG. 1 a diagram is provided of an example hardware arrangement that operates for providing the systems and methods disclosed herein, and designated generally as system 100. System 100 is preferably comprised of one or more information processors 102 at least communicatively coupled to one or more user workstations 104 across communication network 106. User workstations 104 may include, for example, mobile computing devices such as tablet computing devices, smartphones, personal digital assistants or the like. Further, printed output is provided, for example, via output printers 110. For example, output can be provided via output printer 110 and/or other device (e.g., a display screen 214 (FIG. 2)) of a confirmation of the investment of the second portion of the portfolio.

Information processor 102 preferably includes all necessary databases for the present invention, including image files, metadata and other information. However, it is contemplated that information processor 102 can access any required databases via communication network 106 or any other communication network to which information processor 102 has access. Information processor 102 can communicate devices comprising databases using any known communication method, including a direct serial, parallel, USB interface, or via a local or wide area network.

User workstations 104 communicate with information processors 102 using data connections 108, which are respectively coupled to communication network 106. Communication network 106 can be any communication network, but is typically the Internet or some other global computer network. Data connections 108 can be any known arrangement for accessing communication network 106, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User workstations 104 preferably have the ability to send and receive data across communication network 106, and are equipped with web browsers to display the received data on display devices incorporated therewith. By way of example, user workstation 104 may be personal computers such as Intel Pentium-class and Intel Core-class computers or Apple Macintosh computers, but are not limited to such computers. Other workstations which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 106. Of course, one skilled in the art will recognize that wireless devices can communicate with information processors 102 using wireless data communication connections (e.g., WIFI).

According to an embodiment of the present application, user workstation 104 provides user access to information processor 102 for the purpose of receiving and providing information. The specific functionality provided by system 100, and in particular information processors 102, is described in detail below.

System 100 preferably includes software that provides functionality described in greater detail herein, and preferably resides on one or more information processors 102 and/or user workstations 104. One of the functions performed by information processor 102 is that of operating as a web server and/or a web site host. Information processors 102 typically communicate with communication network 106 across a permanent i.e., un-switched data connection 108. Permanent connectivity ensures that access to information processors 102 is always available.

As shown in FIG. 2 the functional elements of each information processor 102 or workstation 104, and preferably include one or more central processing units (CPU) 202 used to execute software code in order to control the operation of information processor 102, read only memory (ROM) 204, random access memory (RAM) 206, one or more network interfaces 208 to transmit and receive data to and from other computing devices across a communication network, storage devices 210 such as a hard disk drive, floppy disk drive, tape drive, CD-ROM or DVD drive or other non-transitory processor readable media for storing program code, databases and application code, one or more input devices 212 such as a keyboard, mouse, track ball and the like, and a display 214.

The various components of information processor 102 need not be physically contained within the same chassis or even located in a single location. For example, as explained above with respect to databases which can reside on storage device 210, storage device 210 may be located at a site which is remote from the remaining elements of information processors 102, and may even be connected to CPU 202 across communication network 106 via network interface 208.

The functional elements shown in FIG. 2 (designated by reference numbers 202-214) are preferably the same categories of functional elements preferably present in user workstation 104. However, not all elements need be present, for example, storage devices in the case of PDAs, and the capacities of the various elements are arranged to accommodate expected user demand. For example, CPU 202 in user workstation 104 may be of a smaller capacity than CPU 202 as present in information processor 102. Similarly, it is likely that information processor 102 will include storage devices 210 of a much higher capacity than storage devices 210 present in work station 104. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, IOS, ANDROID, TORR and various web application development environments.

As used herein, references to displaying data on user workstation 104 refer to the process of communicating data to the workstation across communication network 106 and processing the data such that the data can be viewed on the user workstation 104 display 214 using a web browser or the like. The display screens on user workstation 104 present areas within control allocation system 100 such that a user can proceed from area to area within the control allocation system 100 by selecting a desired link. Therefore, each user's experience with control allocation system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of control allocation system 100.

Although the present application may be shown and described by way of example herein in terms of a web-based system using web browsers and a web site server (information processor 102), and with mobile computing devices (104) system 100 is not limited to that particular configuration. It is contemplated that control allocation system 100 can be arranged such that user workstation 104 can communicate with, and display data received from, information processor 102 using any known communication and display method, for example, using a non-Internet browser Windows viewer coupled with a local area network protocol such as the Internetwork Packet Exchange (IPX). It is further contemplated that any suitable operating system can be used on user workstation 104, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, WINDOWS 8, MAC OS, LINUX, IOS, ANDROID and any suitable PDA or palm computer operating system.

The present application provides, among other features, an automated quantitative model that is useable by an ETF to pay a dividend that is significantly higher than the underlying index on which the ETF is based, and yet still generates the same total return at least as the underlying index. The ETF pays a higher dividend than the underlying index, and still provides a total return (i.e., capital appreciation plus dividend income) that is highly correlated to the index on which the ETF is based. This enables more income to be provided to retired investors that depend on investment income to live on.

In an implementation of the present application, an ETF portfolio is created that is 80-90% based on an underlying index, for example, the S&P 500. The remaining 10-20% of the portfolio is invested using an automated quantitative model to trade stocks that have a very high correlation to the S&P 500. The stocks are bought before the time of an announcement of a dividend and/or payment of a dividend (i.e., before the stock goes ex-divided). The stocks are sold after going ex-dividend. This enables the capture of the dividend, which boosts the dividend yield of the underlying portfolio, and further provides a total return that is consistent with that of the base index.

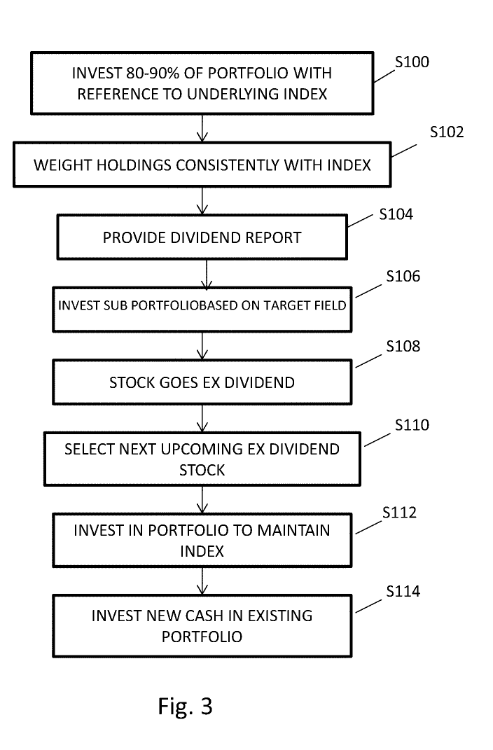

The present application is now described in connection with an example implementation including steps that are provided via one or more processors, and with reference to the flowchart shown in FIG. 3. At the outset at step S100, 80-90% of a portfolio is invested in stocks based on an underlying index e.g. the S&P 500. The holdings of that portion are weighted consistently with the underlying index (step S102). Thereafter, using a system, such as Bloomberg, a daily report is provided that shows all dividends that have been declared globally and are correlated with the underlying index (step S104).

Continuing with reference to the flowchart shown in FIG. 3, the remaining dividend generation sub portfolio is automatically traded in accordance with a quantitative analysis, and investment is made in dividend-paying stocks that are purchased before the ex-date and that are subsequently sold in order to achieve a targeted yield (step S106). As each stock goes ex-dividend and exits the dividend sub generation portfolio (step S108), the quantitative model automatically selects the next upcoming ex-dividend stock from the “dividend generation universe” to add in order to maintain the Beta of 1 (described in greater detail herein), and to generate an optimal return. (step S110). The dividend generation universe continually expands as new dividends are announced and contracts at dividend go ex-dividend.

Continuing with reference to the flowchart shown in FIG. 3, if, after step S110, there is a paucity of dividends to trade, then the excess funds in the index portfolio are invested and index weightings are maintained (step S112). At step S114, new cash invested in the fund is invested in the existing portfolio in order to maintain the weightings of the index. Thereafter, the process ends.

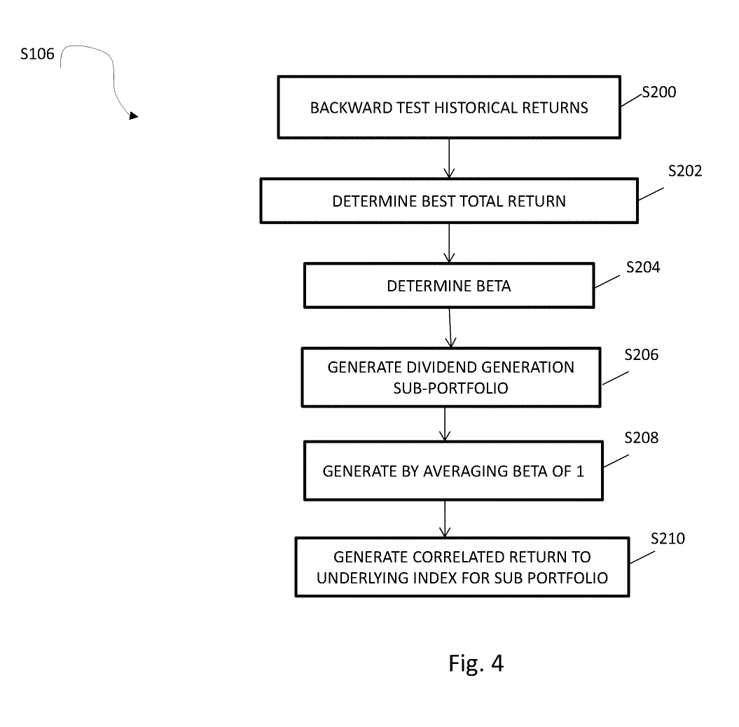

FIG. 4 is a flowchart illustrating example processing steps associated with trading automatically the remaining dividend generation sub portfolio in accordance with the quantitative analysis, substantially as shown and described above (step S106). At step S200, the process begins by backward testing the dividend generation universe's historical returns. This may occur before and after each stock's ex-dividend date in order to determine the optimal holding period for each stock. For example, the number of days is determined before and after the ex-date for each upcoming dividend paying stock that produces the highest total return on average.

Continuing with reference to FIG. 4, at step S202, the optimum financial nature of dividend stocks to trade that produce the best total return are determined through backward testing. Various known techniques to determine this include, for example, valuation metrics (e.g., Price Earnings Ratio), Profit Margins, Dividend Yield, or other suitable way. Thereafter, the Beta is determined quantitatively for the upcoming ex-dividends stocks to the underlying index (step S204).

Once the Beta is determined, a dividend generation sub portfolio is generated (step S206). In an implementation, the sub portfolio is generated by averaging a Beta of 1. In a simple example, a dividend generation sub portfolio includes two stocks. Of course, one of ordinary skill will recognize that, in practice, many stocks may be included in the sub portfolio. Continuing with reference to FIG. 4 and the example implementation described above, dividend stock trade “A” will have a Beta of 1.2 and dividend stock trade “B” will have a Beta of 0.8. The average Beta for the Dividend Generation Sub Portfolio, therefore, is 1. By averaging a Beta of 1, the dividend sub generation portfolio generates a correlated return to underlying index (step S210). Also the portfolio components can be weighted to generate the target average Beta.

In accordance with the present application, the Beta (“β”) of a stock or portfolio refers, generally, to a number describing the correlated volatility of an asset in relation to the volatility of the benchmark that said asset is being compared to. This benchmark is generally the overall financial market and is often estimated via the use of representative indices, such as the S&P 500. Some interpretations of beta are explained as follows.

β<0 Asset generally moves in the opposite direction as compared to the index, for example, Gold, which often moves opposite to the movements of the stock market.

β=0 Movement of the asset is uncorrelated with the movement of the benchmark, for example, Fixed-yield asset, whose growth is unrelated to the movement of the stock market.

0<β<1 Movement of the asset is generally in the same direction as, but less than, the movement of the benchmark, “staple” stock that is, typically, considered stable. For example, a company that makes soap may be considered to be a stable stock because it provides a staple product that people need and will continue to purchase. In this case, the asset moves in the same direction as the market moves generally at large, but is less susceptible to day-to-day fluctuation.

β=1 Movement of the asset is generally in the same direction as, and about the same amount as, the movement of the benchmark A representative stock, or a stock that is a strong contributor to the index itself.

β>1 Movement of the asset is generally in the same direction as, but more than, the movement of the benchmark Volatile stock, such as a tech stock, or stocks which are very strongly influenced by day-to-day market news.

Table 1 shows an example dividend generation universe in accordance with the present application. As shown, ten stocks (A-J) are included, each having a respective Price, Dividend Per Share, Dividend Yield, Dividend Ex-Date, Beta Value And Optimum Days Holding Period. In an implementation, the Optimum Days Holding Period is produced by the quantitative predictive model, and may be based, for example, upon historical data, seasonal data, earnings announcements or declared based on earnings.

### Example of Dividend Generation Universe

TABLE 1

| | | | | | | Optimum |
|---|---|---|---|---|---|---|
| | | Dividend | | | | Days |
| | | Per | Dividend | Dividend | | Holding |
| Stock | Price | Share | Yield | Ex-Date | Beta | Period |
| A | 50 | 0.5 | 1.0% | Jan. 10, 2013 | 1.2 | 30 |
| B | 30 | 0.25 | 0.8% | Jan. 5, 2013 | 1.5 | 33 |
| C | 40 | 0.5 | 1.3% | Jan. 8, 2013 | 0.5 | 22 |
| D | 20 | 0.3 | 1.5% | Jan. 12, 2013 | 0.8 | 19 |
| E | 25 | 0.35 | 1.4% | Jan. 1, 2013 | 0.6 | 23 |
| F | 35 | 0.4 | 1.1% | Jan. 1, 2013 | 1.1 | 18 |
| G | 55 | 0.6 | 1.1% | Jan. 11, 2013 | 1.3 | 31 |
| H | 10 | 0.2 | 2.0% | Jan. 9, 2013 | 1.4 | 25 |
| I | 15 | 0.13 | 0.9% | Jan. 12, 2013 | 0.7 | 22 |
| J | 45 | 0.55 | 1.2% | Jan. 18, 2013 | 0.5 | 19 |
| Average | | | 1.2% | | 0.96 | |

Table 2 shows an example Dividend Generation Sub Portfolio. In the example Table 2, stocks “F” and “J” were left out to optimize the Beta)

TABLE 2

| | | | | | | Optimum |
|---|---|---|---|---|---|---|
| | | Dividend | | | | Days |
| | | Per | Dividend | Dividend | | Holding |
| Stock | Price | Share | Yield | Ex-Date | Beta | Period |
| A | 50 | 0.5 | 1.0% | Jan. 10, 2013 | 1.2 | 30 |
| B | 30 | 0.25 | 0.8% | Jan. 5, 2013 | 1.5 | 33 |
| C | 40 | 0.5 | 1.3% | Jan. 8, 2013 | 0.5 | 22 |
| D | 20 | 0.3 | 1.5% | Jan. 12, 2013 | 0.8 | 19 |
| E | 25 | 0.35 | 1.4% | Jan. 14, 2013 | 0.6 | 23 |
| F | | | | | | 18 |
| G | 55 | 0.6 | 1.1% | Jan. 11, 2013 | 1.3 | 31 |
| H | 10 | 0.2 | 2.0% | Jan. 2, 2013 | 1.4 | 25 |
| I | 15 | 0.13 | 0.9% | Jan. 12, 2013 | 0.7 | 22 |
| J | | | | | | 19 |
| Average | | | 1.2% | | 1 | |

Table 3 shows the example dividend generation universe of Table 1, with weighted Beta values. Table 3 further includes Expected Return percentages and Weighted Return percentages.

### Weighting Example

### Equal

TABLE 3

| | | | | | | | | Optimum | | |
|---|---|---|---|---|---|---|---|---|---|---|
| | | | Dividend | | | | | Days | | |
| | | | Per | Dividend | Dividend | | Weighted | Holding | Expected | Weighted |
| Stock | Weighting | Price | Share | Yield | Ex-Date | Beta | Beta | Period | Return | return |
| A | 10% | 50 | 0.5 | 1.00% | Jan. 10, 2013 | 1.2 | 0.12 | 30 | 5% | 1% |
| B | 10% | 30 | 0.25 | 0.80% | Jan. 5, 2013 | 1.5 | 0.15 | 33 | 3% | 0% |
| C | 10% | 40 | 0.5 | 1.30% | Jan. 8, 2013 | 0.5 | 0.05 | 22 | 3% | 0% |
| D | 10% | 20 | 0.3 | 1.50% | Jan. 12, 2013 | 0.8 | 0.08 | 19 | 2% | 0% |
| E | 10% | 25 | 0.35 | 1.40% | Jan. 14, 2013 | 0.6 | 0.06 | 23 | 3.50% | 0% |
| F | 10% | 35 | 0.4 | 1.10% | Jan. 3, 2014 | 1.1 | 0.11 | 18 | 3.70% | 0% |
| G | 10% | 55 | 0.6 | 1.10% | Jan. 11, 2013 | 1.3 | 0.13 | 31 | 3% | 0% |
| H | 10% | 10 | 0.2 | 2.00% | Jan. 9, 2013 | 1.4 | 0.14 | 25 | 3% | 0% |
| I | 10% | 15 | 0.13 | 0.90% | Jan. 12, 2013 | 0.7 | 0.07 | 22 | 2% | 0% |
| J | 10% | 45 | 0.55 | 1.20% | Jan. 18, 2013 | 0.5 | 0.05 | 19 | 1.50% | 0% |
| Average | 100% | | | 1.20% | | 0.96 | 0.96 | | | 2.92% |

In one or more implementations, stocks are ranked based on performance, and weighted differently as a function of the ranking. For example, the top 10% of stocks are weighted more heavily than the bottom 10% of stocks. Stocks selected for replacement may be made the same way as during initial selection. Weighting may be performed based on the expected total return to meet the yield, which may be yield per month, yield per quarter to meet the year.

Table 4 shows the example dividend generation universe of Table 3, optimized in accordance with the teachings herein. The optimization of Table 4 is reflected in the weighting percentages and corresponding weighted Beta values.

### Optimized

TABLE 4

| | | | | | | | | Optimum | | |
|---|---|---|---|---|---|---|---|---|---|---|
| | | | | | | | | Days | | |
| | | | Dividend | Dividend | Dividend | | Weighted | Holding | Expected | Weighted |
| Stock | Weighting | Price | Per Share | Yield | Ex-Date | Beta | Beta | Period | Return | return |
| A | 15% | 50 | 0.5 | 1.00% | Jan. 10, 2013 | 1.2 | 0.18 | 30 | 5% | 1% |
| B | 10% | 30 | 0.25 | 0.80% | Jan. 5, 2013 | 1.5 | 0.15 | 33 | 3% | 0% |
| C | 9% | 40 | 0.5 | 1.30% | Jan. 8, 2013 | 0.5 | 0.045 | 22 | 3% | 0% |
| D | 8% | 20 | 0.3 | 1.50% | Jan. 12, 2013 | 0.8 | 0.064 | 19 | 2% | 0% |
| E | 11% | 25 | 0.35 | 1.40% | Jan. 14, 2013 | 0.6 | 0.066 | 23 | 3.50% | 0% |
| F | 12% | 35 | 0.4 | 1.10% | Jan. 3, 2013 | 1.1 | 0.132 | 18 | 3.70% | 0% |
| G | 10% | 55 | 0.6 | 1.10% | Jan. 11, 2013 | 1.3 | 0.13 | 31 | 3% | 0% |
| H | 10% | 10 | 0.2 | 2.00% | Jan. 9, 2013 | 1.4 | 0.14 | 25 | 3% | 0% |
| I | 9% | 15 | 0.13 | 0.90% | Jan. 12, 2013 | 0.7 | 0.063 | 22 | 2% | 0% |
| J | 6% | 45 | 0.55 | 1.20% | Jan. 18, 2013 | 0.5 | 0.03 | 19 | 1.50% | 0% |
| Average | 100% | | | 1.20% | | 0.96 | 1.00 | | | 3.13% |

In accordance with an implementation of the present application, quantitative rules are provided that determine stock selection. For example, a minimum portfolio size is defined to thirty (30) stocks. A minimum position size is defined to one half of 1 percent (0.5%). Further a variable, target yield X, is defined per quarter and, further, a target Beta is defined to be between 2+−1%.

In an implementation, quantitative analysis back tests for ten years for all stocks globally that pay a dividend with a yield of at least 2% for a given period. Thereafter, an assessment is made to determine which financial characteristics produce the returns that satisfy one or more benchmarks. For example, the highest returns associated with a price-earnings (“P/E”) ratio, earnings per share (“EPS”) growth, Dividend Yield or other suitable measurement, as well as average returns, for all the holding days before and after the ex-date.

In accordance with the present application, the quantitative analysis is applied to the current dividend paying universe, and used to produce a report. The report forecasts all the holding periods in days, before and after the ex-date, for each stock during the quarter that produce a total return above 2%. This is shown in the example table 5 below:

TABLE 5

| | Expected | | | | | | | | | |
|---|---|---|---|---|---|---|---|---|---|---|
| Stock A | Return | | | | | | | | | |
| Holding Period | Days After Ex | | | | | | | | | |
| Days Before Ex | 1 | 2 | 3 | 4 | 5 | 6 | 7 | 8 | 9 | 10 |
| 1 | 0.0% | 0.7% | 0.5% | 0.6% | −1.0% | −0.2% | 0.3% | 0.1% | 0.6% | 0.2% |
| 2 | 1.0% | 1.5% | 1.3% | 1.4% | −0.2% | 0.6% | 1.1% | 0.9% | 1.4% | 1.0% |
| 3 | 0.5% | 1.0% | 0.8% | 0.9% | −0.7% | 0.1% | 0.6% | 0.4% | 0.9% | 0.5% |
| 4 | −0.5% | 0.0% | −0.3% | −0.2% | −1.7% | −0.9% | −0.4% | −0.6% | −0.1% | −0.5% |
| 5 | −1.0% | −0.5% | −0.8% | −0.7% | −2.2% | −1.4% | −0.9% | −1.1% | −0.6% | −1.0% |
| 6 | 2.0% | 2.5% | 2.3% | 2.4% | 0.9% | 1.6% | 2.1% | 1.9% | 2.4% | 2.0% |
| 7 | 3.0% | 3.5% | 3.3% | 3.4% | 1.9% | 2.6% | 3.1% | 2.9% | 3.4% | 3.0% |
| 8 | 4.0% | 4.5% | 4.3% | 4.4% | 2.9% | 3.6% | 4.1% | 3.9% | 4.4% | 4.0% |
| 9 | 5.5% | 6.0% | 5.8% | 5.9% | 4.4% | 5.1% | 5.6% | 5.4% | 5.9% | 5.5% |
| 10 | 5.0% | 5.5% | 5.3% | 5.4% | 3.9% | 4.6% | 5.1% | 4.9% | 5.4% | 5.0% |

In the example shown in Table 5, analysis will start 60 days before and 30 days after ex-date of dividend. Application of the rules and data shown and described above produce a portfolio that meets the yield objective and average Beta objective and maximizes total return.

The present application supports various alternative implementations. For example, the automated quantitative model is usable to generate a higher yield than the underlying portfolio based on an index for index based mutual funds and index based structured products.

In yet a further alternative use is in a 130/30 mutual fund or ETF which includes 100% long portfolio plus 30% leverage and a neutralizing 30% short position. In this situation the dividend sub generation portfolio would be in the extra 30% funded by leverage and the relative index would be shorted.

In yet another alternative, a plurality of operating “modes” may be defined, which affects the degree to which stocks are weighted. For example a “Low” mode may be defined in connection with a percentage of the portfolio that is subjected to the rules set forth herein. A “Mid” mode may depend upon the Beta value, such as defined to be 1.1, 1.2, or other suitable value. In a third, “High” mode, a percentage value, such as 20% that calculates for a higher Beta value, in connection with a smaller sized portfolio and that calculates a lower Beta value, in connection with a larger sized portfolio. In this alternative embodiments, a customized operation may be included depending upon the respective traders' preference. Moreover, a plurality of Beta values may be used for defining respective operating modes. Thus, the present application supports tremendous flexibility in connection with design implementations and operations.

Thus, the present application provides a solution over known ETF trading by increasing return, while mitigating or otherwise eliminating corresponding risk. In an implementation, investment performance is provided that is based on the underlying index (e.g., S&P 500) with an enhanced dividend yield. The enhanced dividend yield may be produced by operating a 130/30 strategy. For example, 100% of the fund may be invested in the underlying index, 30% may be invested in a dividend capture basket of global dividend stocks, and a corresponding 30% short in the relevant countries index (via an ETF or Future). The 30% short in the relevant countries index is expected to neutralize the country and currency risk associated with that basket. Thereafter, as dividends globally are paid seasonally, the basket will change during the year to different global stock markets. Accordingly, the short will change, in relation to the market that is being invested in.

In addition to the example implementations shown and described herein, another and alternative implementation of the present application regards a pair strategy. In this example implementation, one or more stocks in the index is respectively paired with another stock with a similar beta and industry exposure. The portfolio trades between the pairs of stocks buying before dividend ex dates and selling after ex-dividend date collecting multiple dividends a year in excess of if just the single stock was held. For example a utility that paid a dividend in January, April, July, and October would be paired with another utility with a similar beta that pays a dividend in March, June, September and December. The portfolio would switch between the two stocks every February, May, August and November.

Although the present application has been described in relation to particular embodiments thereof, other variations and modifications and other uses are included herein. It is preferred, therefore, that the present invention not be limited by the specific disclosure herein.

What is claimed:

1. A computer implemented method using an exchange traded fund to receive a dividend that exceeds at least one underlying market index on which the exchange traded fund is based, and earning a total return that is correlated to the at least one underlying index, the method comprising:
accessing, by at least one processor configured by executing code, at least one database, wherein the at least one database includes security information representing:
respective securities,
at least one respective security price for each of at least one of the respective securities,
at least one respective ex-dividend date for each of at least one of the respective securities, and
at least one respective dividend yield for each of at least one of the respective securities, wherein the ex-dividend date represents a date when a dividend is announced or paid;
receiving, by the at least one processor, investment information representing a first portion of a portfolio that includes one or more investments in one or more securities in relation to the at least one underlying index;
processing, by the at least one processor, the investment information and at least some of the security information in the at least one database to determine a second portion of the portfolio that represents less than half of the first portion of the portfolio and that includes at least two of the respective securities to be purchased prior to the respective ex-dividend date for each of the at least two securities;
initiating, by the at least one processor, an investment in each of the at least two securities; and
outputting a confirmation of the investment of the second portion of the portfolio.

2. The computer implemented method of claim 1, further comprising:
initiating, by the at least one processor, a sale of any portion of the portfolio that has paid a dividend;
identifying, by the at least one processor, at least one other of the securities, to be purchased prior to the respective ex-dividend date for each of the at least one other of the securities;
initiating, by the at least one processor, an investment in each of the at least one other of the securities; and
outputting a confirmation of the investment of the at least one other of the securities.

3. The computer implemented method of claim 1, wherein processing, by the at least one processor, to determine a second portion of the portfolio further comprises:
identifying, by the at least one processor, historical returns of at least some of the respective securities in the at least one database;
identifying, by the at least one processor an optimal holding period for at least some of the respective securities; and
determining a Beta value that represents a correlated volatility for one or more of the securities having an ex-dividend date within a respective range in relation to a volatility of a benchmark the one or more securities are compared to.

4. The computer implemented method of claim 3, wherein the identifying the historical returns includes one or more identifying valuation metrics, profit margins and dividend yields.

5. The computer implemented method of claim 3, further comprising:
ranking, by the at least one processor, at least some of the securities based on performance; and
applying, by the at least one processor, a numerical weight value to each of the at least some of the securities as a function of the ranking.

6. The computer implemented method of claim 5, wherein applying the numerical weight value is based on an expected total return to meet a yield.

7. The computer implemented method of claim 1, wherein processing, by the at least one processor, to determine a second portion of the portfolio further comprises:
determining, by the at least one processor, at least one of highest returns associated with a price-earnings ratio, earnings per share growth, dividend yield, and average return, for each of the at least two securities during holding days before and after the respective ex-dividend date.

8. The computer implemented method of claim 1, wherein the total return includes total capital appreciation plus dividend income.

9. The computer implemented method of claim 1, wherein the underlying index is based on mutual funds and/or structured products.

10. The computer implemented method of claim 1, further comprising operating, by the at least one processor, at least one of a low mode without a Beta value, a middle mode with a Beta value and a high mode with a predetermined percentage value.

11. The computer implemented method of claim 1, further comprising:
pairing, by the at least one processor, at least one of the securities with another security having a similar Beta value and/or industry exposure; and
alternating buying and selling the paired securities as a function of each respective security's ex-dividend date.

12. A system for using an exchange traded fund to receive a dividend that exceeds at least one underlying market index on which the exchange traded fund is based, and earning a total return that is correlated to the at least one underlying index, the system comprising:
at least one processor configured by executing code that is stored on non-transitory processor readable media;
at least one database that is accessible by the at least one processor, wherein the at least one database includes security information representing:
respective securities,
at least one respective security price for each of at least one of the respective securities,
at least one respective ex-dividend date for each of at least one of the respective securities, and
at least one respective dividend yield for each of at least one of the respective securities, wherein the ex-dividend date represents a date when a dividend is announced or paid;
wherein the one or more processor readable media have instructions for causing the following steps to be performed by at least one processor:
receiving, by the at least one processor, investment information representing a first portion of a portfolio that includes one or more investments in one or more securities in relation to the at least one underlying index;
processing, by the at least one processor, the investment information and at least some of the security information in the at least one database to determine a second portion of the portfolio that represents less than half of the first portion of the portfolio and that includes at least two of the respective securities to be purchased prior to the respective ex-dividend date for each of the at least two securities;
initiating, by the at least one processor, an investment in each of the at least two securities; and
outputting a confirmation of the investment of the second portion of the portfolio.

13. The system of claim 12, wherein the non-transitory processor readable media have instructions for causing the following steps further to be performed by the at least one processor:
initiating, by the at least one processor, a sale of any portion of the portfolio that has paid a dividend;
identifying, by the at least one processor, at least one other of the securities, to be purchased prior to the respective ex-dividend date for each of the at least one other of the securities;
initiating, by the at least one processor, an investment in each of the at least one other of the securities; and
outputting a confirmation of the investment of the at least one other of the securities.

14. The system of claim 12, wherein processing, by the at least one processor, to determine a second portion of the portfolio further comprises:
identifying, by the at least one processor, historical returns of at least some of the respective securities in the at least one database;
identifying, by the at least one processor an optimal holding period for at least some of the respective securities; and
determining a Beta value that represents a correlated volatility for one or more of the securities having an ex-dividend date within a respective range in relation to a volatility of a benchmark the one or more securities are compared to.

15. The system of claim 14, wherein the identifying the historical returns includes one or more identifying valuation metrics, profit margins and dividend yields.

16. The system of claim 14, wherein the non-transitory processor readable media have instructions for causing the following steps further to be performed by the at least one processor:
ranking, by the at least one processor, at least some of the securities based on performance; and
applying, by the at least one processor, a numerical weight value to each of the at least some of the securities as a function of the ranking.

17. The system of claim 16, wherein applying the numerical weight value is based on an expected total return to meet a yield.

18. The system of claim 12, wherein processing, by the at least one processor, to determine a second portion of the portfolio further comprises:
determining, by the at least one processor, at least one of highest returns associated with a price-earnings ratio, earnings per share growth, dividend yield, and average return, for each of the at least two securities during holding days before and after the respective ex-dividend date.

19. The system of claim 12, wherein the total return includes total capital appreciation plus dividend income.

20. The system of claim 12, wherein the underlying index is based on mutual funds and/or structured products.

21. The system of claim 12, wherein the non-transitory processor readable media have instructions for causing the following steps further to be performed by the at least one processor:
operating, by the at least one processor, at least one of a low mode without a Beta value, a middle mode with a Beta value and a high mode with a predetermined percentage value.

22. The system of claim 12, wherein the non-transitory processor readable media have instructions for causing the following steps further to be performed by the at least one processor:
pairing, by the at least one processor, at least one of the securities with another security having a similar Beta value and/or industry exposure; and
alternating buying and selling the paired securities as a function of each respective security's ex-dividend date.

23. A computer implemented method comprising:
initiating, with respect to a first portion of a portfolio, one or more first transactions, the one or more first transactions comprising one or more investments in one or more securities in relation to one or more market indices;
identifying one or more securities with respect to which (a) a dividend has been declared and (b) that are correlated to the one or more market indices;
for each of the identified one or more securities:
processing historical data associated with the security, the historical data comprising (a) one or more returns occurring before an ex-dividend date of the security and (b) one or more returns occurring after an ex-dividend date of the security, in order to determine an optimal holding period for the security; and
determining, with one or more processors, a correlated volatility value of the security with respect to the one or more securities;
processing the respective correlated volatility values of each of the identified one or more securities in order to determine one or more of the identified one or more securities having an aggregate comparable volatility to the one or more market indices; and
for each of the determined one or more of the identified one or more securities:
initiating, prior to an ex-dividend date of the security and with respect to a second portion of the portfolio, an investment in the security; and
based on a determination that an ex-dividend date of the security has arrived, initiating one or more second transactions with respect to the determined one or more of the identified one or more securities.

24. The method of claim 23, wherein the one or more second transactions comprise a sale of the security.

25. The method of claim 23, wherein the one or more second transactions comprise an investment in another security.

26. The method of claim 23, wherein the one or more second transactions comprise one or more investments in one or more securities in relation to the one or more market indices.

27. The method of claim 23, wherein the one or more second transactions comprise a sale of the security.

28. The method of claim 23, wherein initiating one or more first transactions comprises weighting the one or more investments in the one or more securities in relation to the one or more market indices.
